(19) United States
(12) Patent Application Publication
(10) Pub. No.: US 2016/0242388 A1
(43) Pub. Date: Aug. 25, 2016

(54) Animal Amusement System

(71) Applicant: AWOW, LLC, Chicago, IL (US)

(72) Inventor: Joe Y. Chiou, Wilmette, IL (US)

(73) Assignee: AWOW, LLC

(21) Appl. No.: 14/628,569

(22) Filed: Feb. 23, 2015

(51) Int. Cl. A01K 15/02

(52) U.S. Cl. CPC A01K 15/024; A01K 15/025

(57) ABSTRACT

An animal amusement system for entertaining an animal such as a cat while also providing an area for the animal to lounge. The animal amusement system generally includes a track with an upper portion removably connected to a lower portion to define a channel. A ball may be positioned in the channel so that it may be swatted around. One or more openings formed in the upper portion of the track provide viewing of the underlying channel. Enclosed portions separate the openings, and provide the illusion of a ball disappearing as it passes thereunder. Ball stops may also be provided which impeded or slow the movement of the balls to the further amusement of an animal. An optional insert may be provided and inserted within a central opening of the track defined by its inner edge. An animal may rest or scratch upon the insert between playing with the balls.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to an amusement device and more specifically it relates to an animal amusement system for entertaining an animal such as a cat while also providing an area for the animal to lounge.

2. Description of the Related Art

Any discussion of the related art throughout the specification should in no way be considered as an admission that such related art is widely known or forms part of common general knowledge in the field.

For as long as animals have been domesticated, their human companions have been seeking ways to keep such animals entertained. There is a large industry built solely around toys, chews, bones, treats, and the like for entertaining pets. It is also well-known that certain animals (such as cats) can be destructive if left unattended without any entertainment or amusement options. While there are a range of toys and amusement devices in the field, none are particularly suited for both allowing a lounging area and for providing the unique experience of chasing a toy around a track.

Because of the inherent problems with the related art, there is a need for a new and improved animal amusement system for entertaining an animal such as a cat while also providing an area for the animal to lounge.

### BRIEF SUMMARY OF THE INVENTION

The invention generally relates to an amusement device which includes a track which includes an upper portion removably connected to a lower portion to define a channel therebetween. One or more balls are positioned in the channel so that they may be swatted around therein. One or more openings are formed in the upper portion of the track to provide viewing of the underlying channel. Enclosed portions separate the openings, and provide the illusion of a ball disappearing as it passes thereunder. Ball stops may also be provided which impeded or slow the movement of the balls to the further amusement of an animal. An optional insert may be provided and inserted within a central opening of the track defined by its inner edge. An animal may rest or scratch upon the insert between playing with the balls.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is an upper perspective view of the present invention with upper and lower portion's disconnected.

FIG. 3 is a top view of the present invention.

FIG. 4 is a bottom view of the present invention.

FIG. 5 is a front sectional view of the present invention.

FIG. 6 is a side sectional view of the present invention.

FIG. 7 is an upper perspective view of the present invention with base and insert.

FIG. 8 is an upper perspective view of the present invention with upper and lower portions and insert disconnected.

FIG. 9 is a top view of the present invention with insert.

FIG. 10 is a bottom view of the present invention with base.

FIG. 11 is a frontal view of the present invention with insert.

FIG. 12 is a rear view of the present invention with insert.

FIG. 13 is a side view of the present invention with insert.

FIG. 14 is a front sectional view of the present invention with insert.

FIG. 15 is a side sectional view of the present invention with insert.

### DETAILED DESCRIPTION OF THE INVENTION

### A. Overview

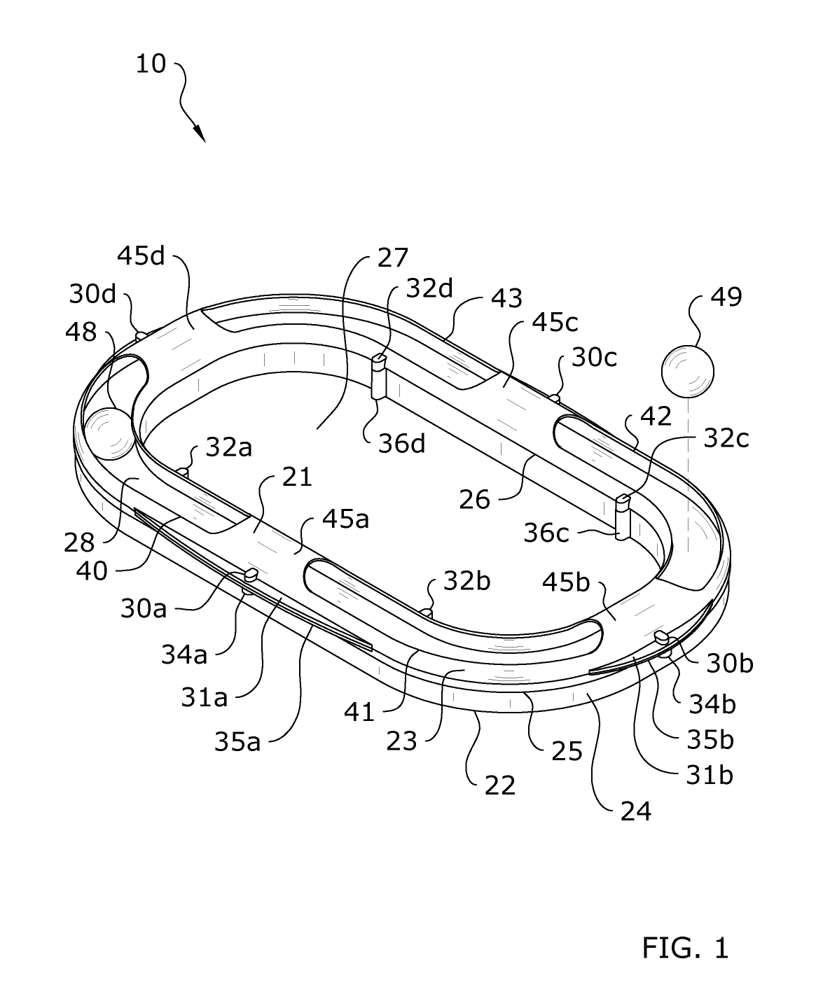

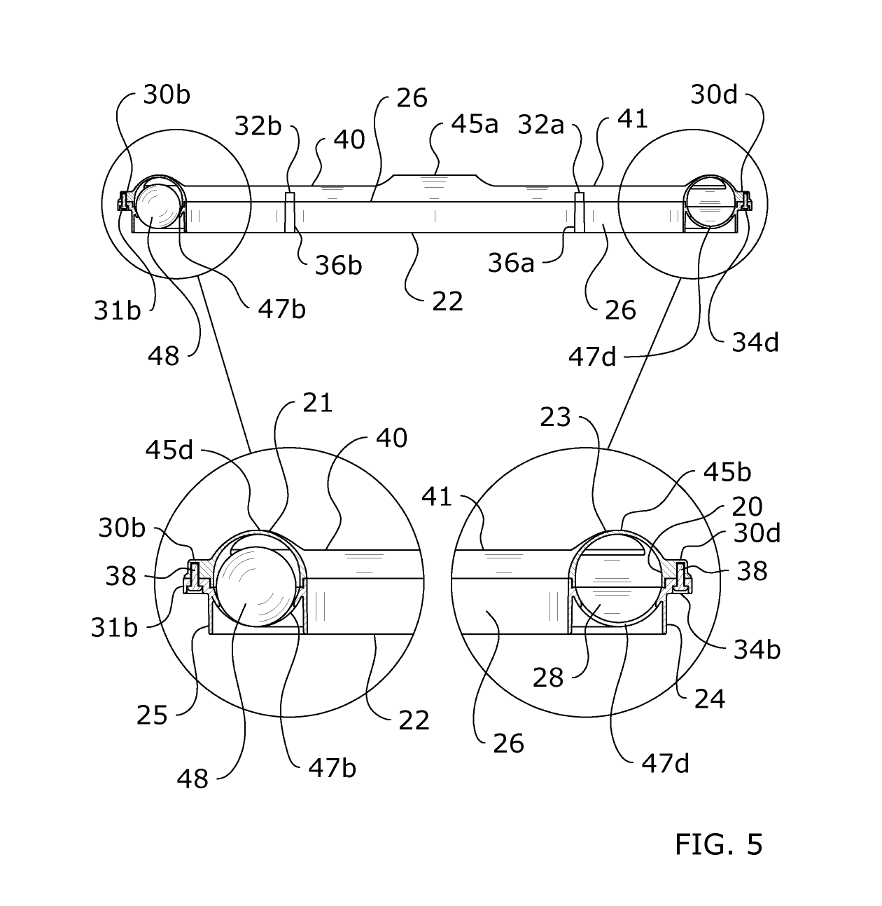

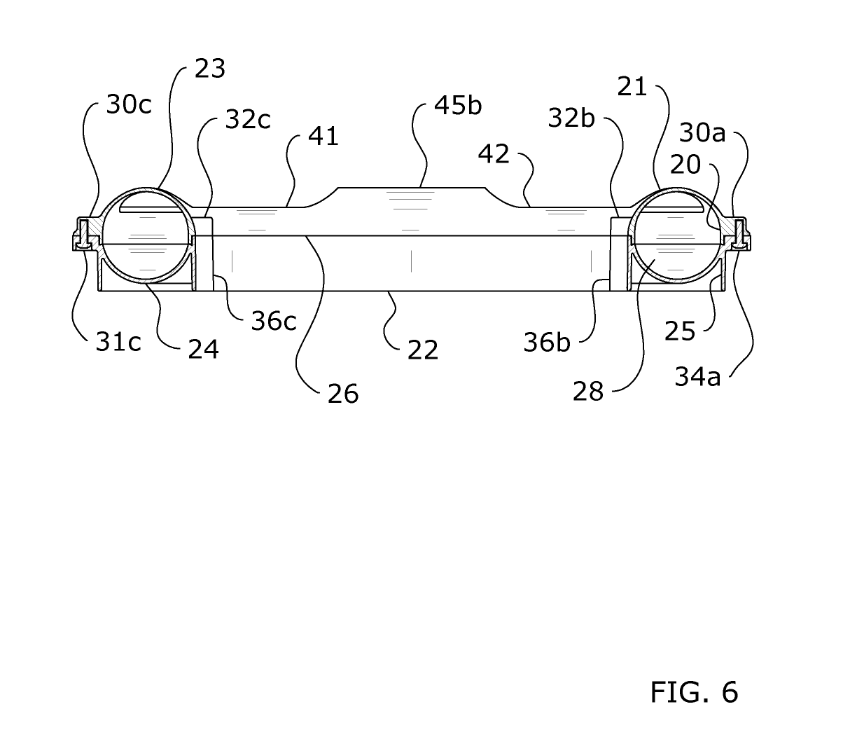

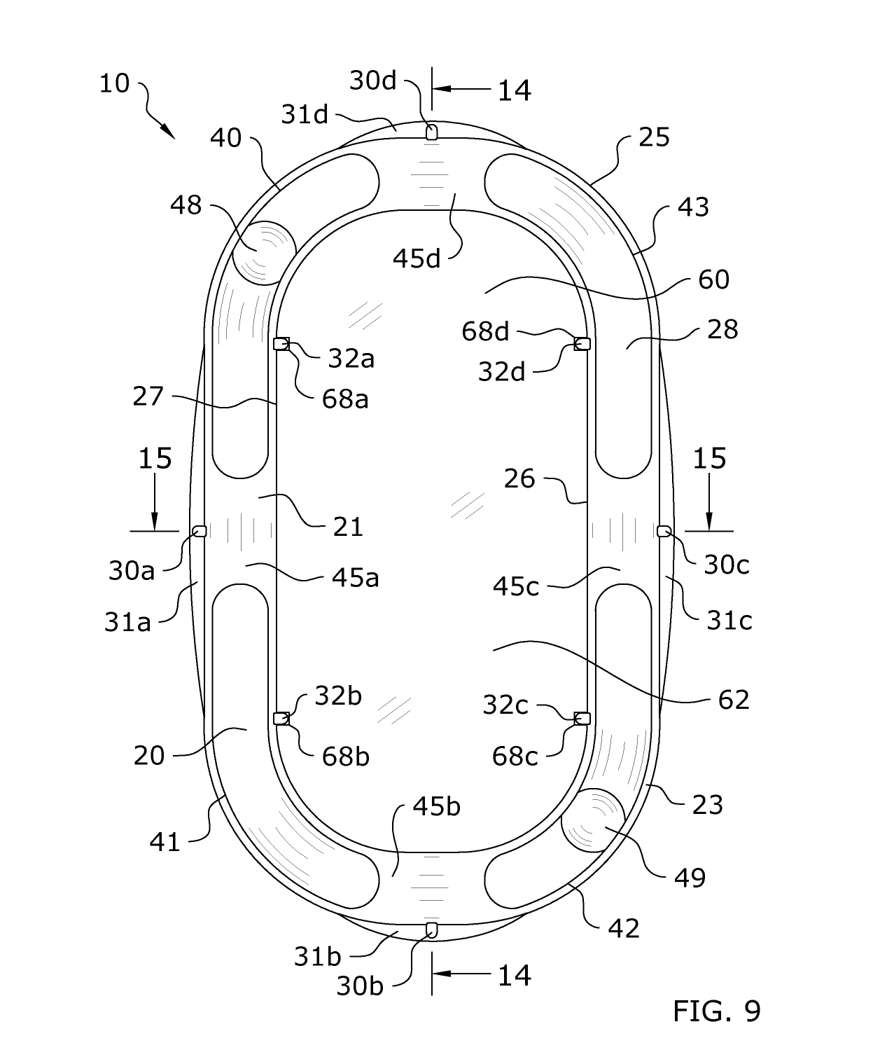

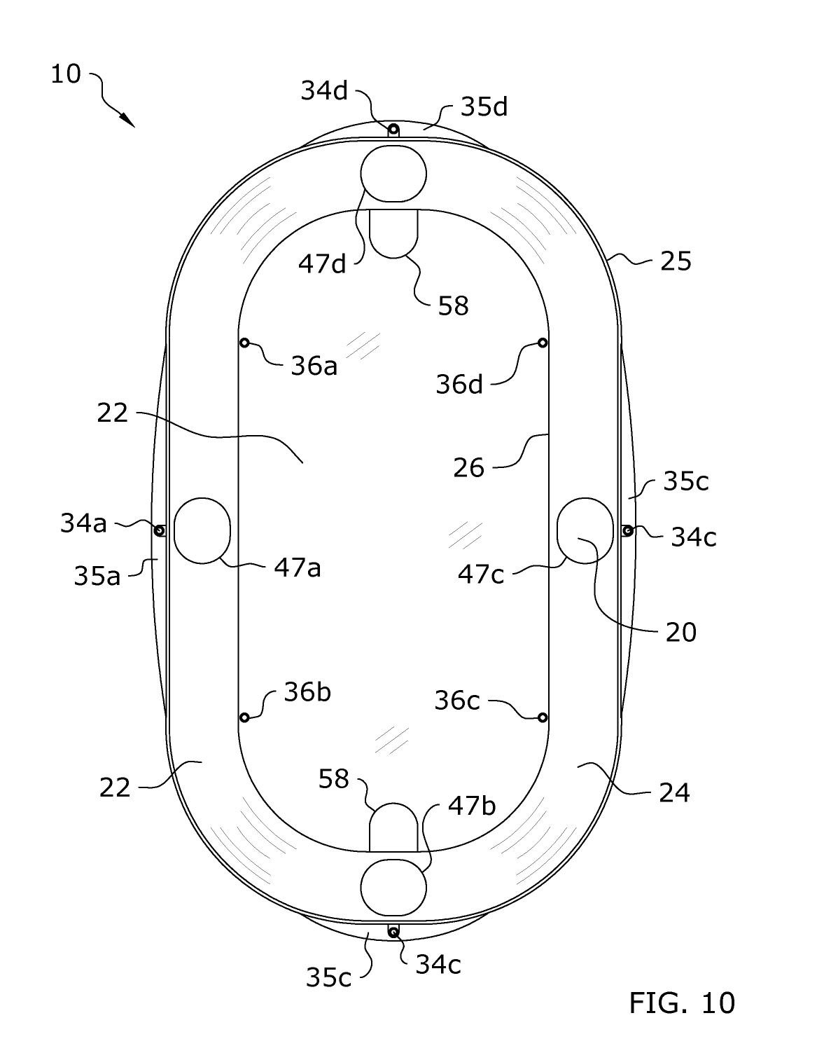

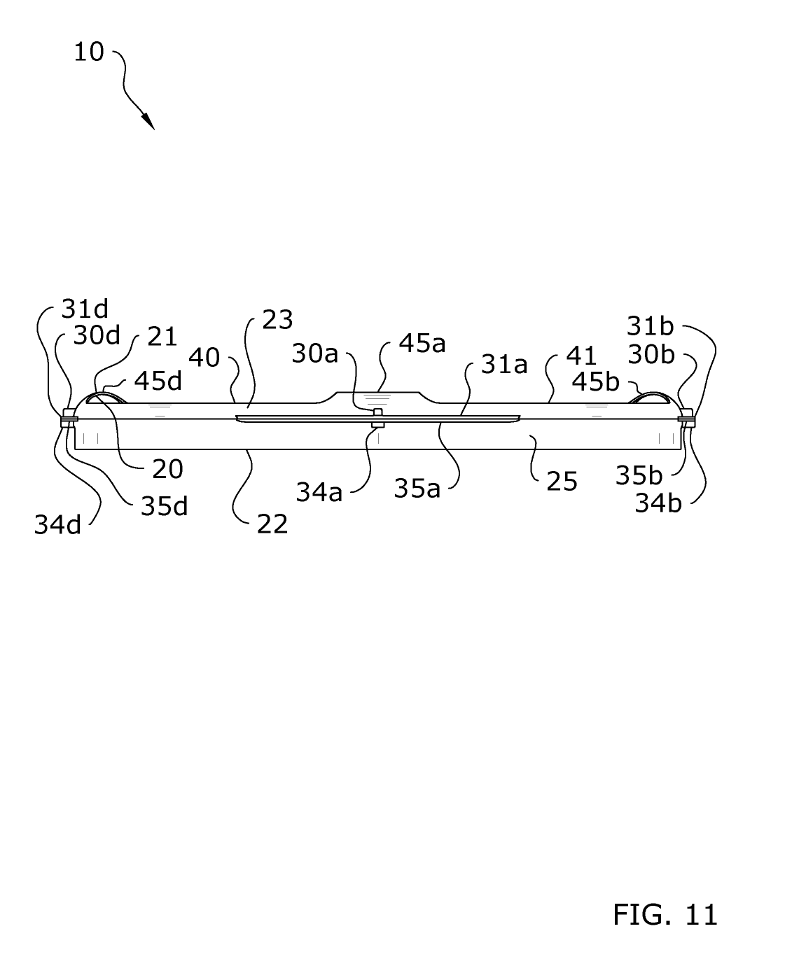

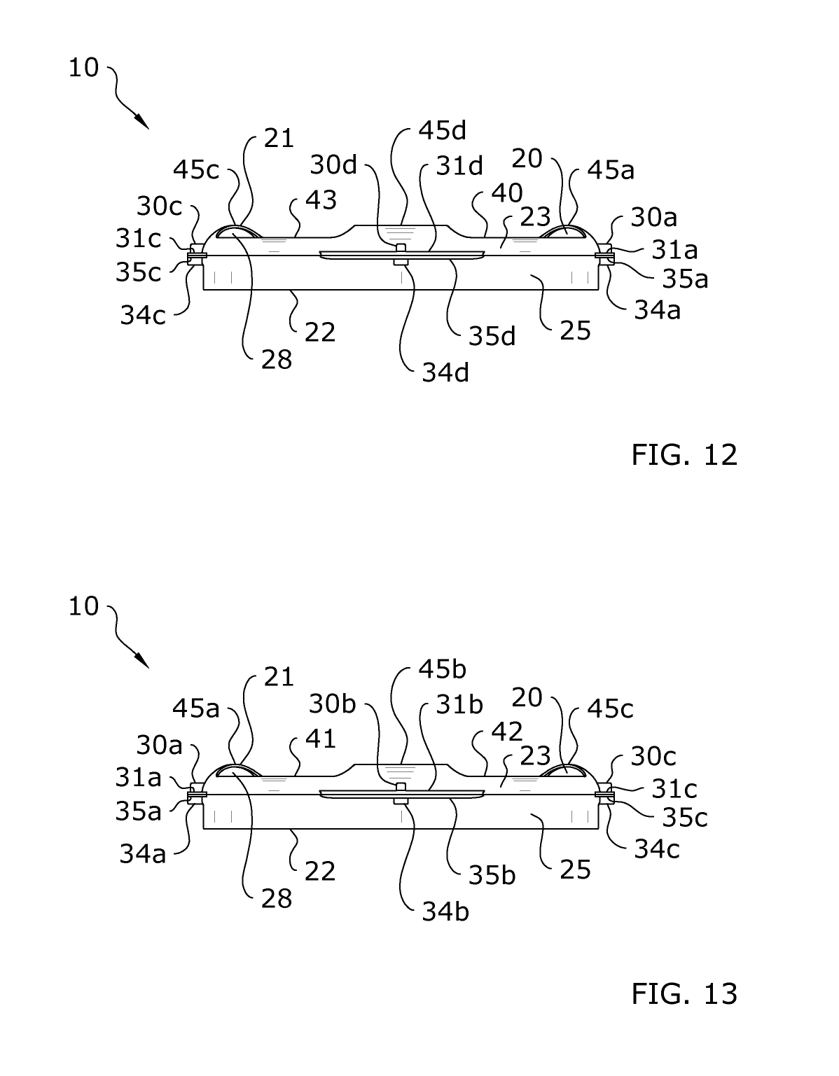

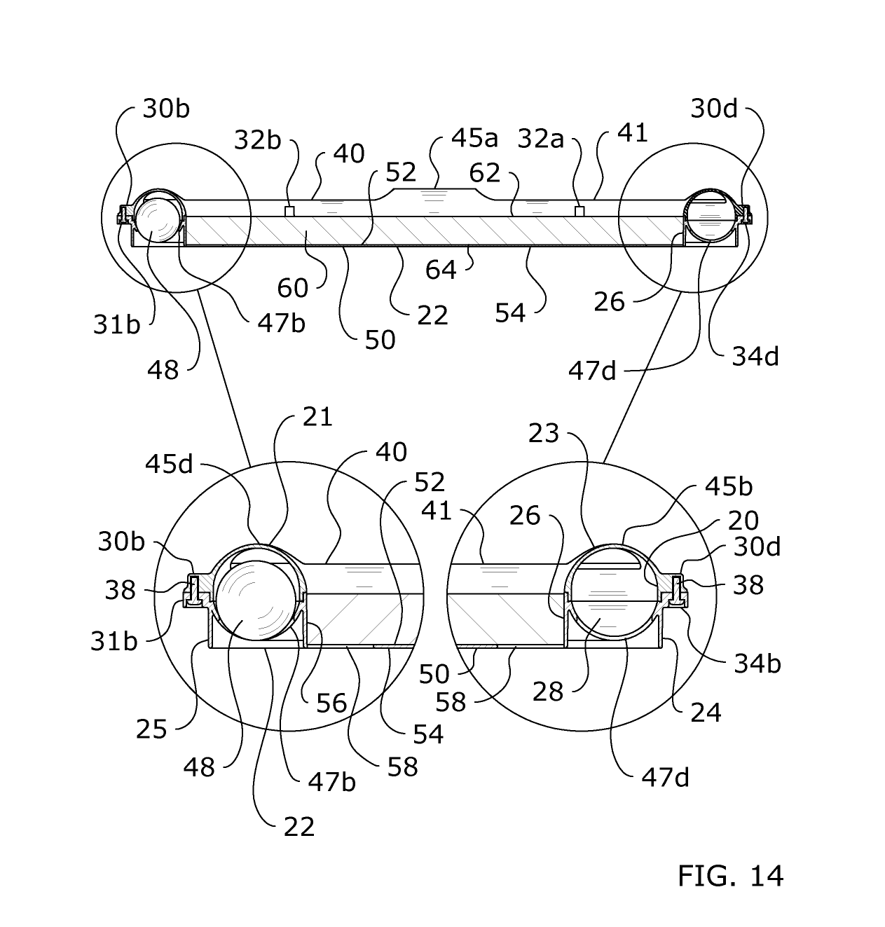

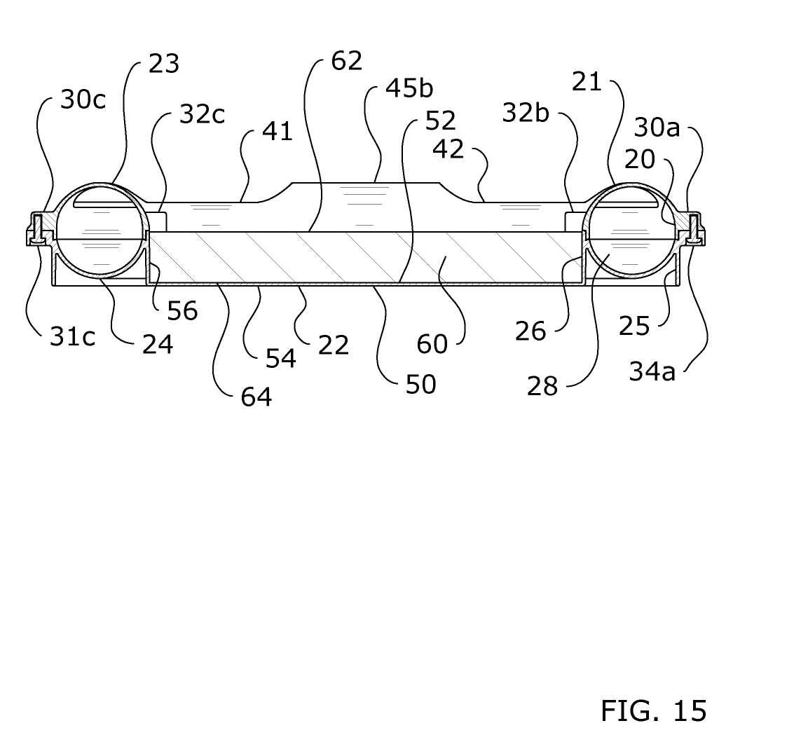

Turning now descriptively to the drawings, in which similar reference characters denote similar elements throughout the several views, FIGS. 1 through 15 illustrate an animal amusement system 10, which comprises a track 20 which includes an upper portion 23 removably connected to a lower portion 24 to define a channel 28 therebetween. One or more balls 48, 49 are positioned in the channel 28 so that they may be swatted around therein. One or more openings 40, 41, 42, 43 are formed in the upper portion 23 of the track 20 to provide viewing of the underlying channel 28. Enclosed portions 45 separate the openings 40, 41, 42, 43 and provide the illusion of a ball 48, 49 disappearing as it passes thereunder. Ball stops 47 may also be provided which impeded or slow the movement of the balls 48, 49 to the further amusement of an animal. An optional insert 60 may be provided and inserted within a central opening 27 of the track 20 defined by its inner edge 26. An animal may rest or scratch upon the insert 60 between playing with the balls 48, 49.

### B. Track

As shown throughout the figures, the present invention includes a track 20 in which one or more balls 48, 49 may be played with by an animal. The shape, size, and configuration of the track 20 may vary in different embodiments of the present invention. Although the figures illustrate a round track 20, it should be appreciated that any number of shapes could be utilized for the track 20.

The track 20 will often include one or more bends and, in some embodiments, may include one or more corners or the like to further alter the free motion of the balls 48, 49. The angles of the bends and/or corners included in the track 20 may also vary. The track 20 need not be comprised of a closed configuration as shown in the figures, but in some embodiments may instead have distinct start and end points.

The track 20 may comprise a single, unitary structure having an upper end 21 and a lower end 22. In a preferred embodiment shown in the figures, the track 20 comprises an upper portion 23 which is removably connected to the lower portion 24. Such a configuration allows for the interior portions of the track 20 to be cleaned when necessary, such as after an accumulation of fur or dust. In such a configuration as shown in the figures, the upper end 21 of the track 20 is on the upper portion 23 and the lower end 22 of the track 20 is on the lower portion 24.

In the exemplary embodiment shown in the figures, the track 20 comprises an oval-shaped configuration with an outer edge 25, an inner edge 26, and a central opening 27 defined by the inner edge 26. However, the track 20 need not necessarily comprise a closed-loop shape and thus in some embodiments may not include such a central opening 27, an inner edge 26, and/or an outer edge 25. In embodiments including a central opening 27, an optional insert 60 may be provided in some embodiments as described herein. Although the figures illustrate that the lower portion 24 of the track 20 has a level surface, it should be appreciated that the lower portion 24 of the track 20 could have a wavy or bumpy surface.

The upper and lower portions 23, 24 of the track 20 define a channel 28 through which the balls 48, 49 of the present invention are forced. In embodiments in which the track 20 is a unitary structure, an internal channel 28 will extend through the unitary structure. Although the figures illustrate that the channel 28 extends for the entire length of the track 20, in some embodiments the channel 28 may extend for only a portion of the length of the track 20 to limit the range of motion of the balls 48, 49 to specific areas of the track 20.

### C. Connectors

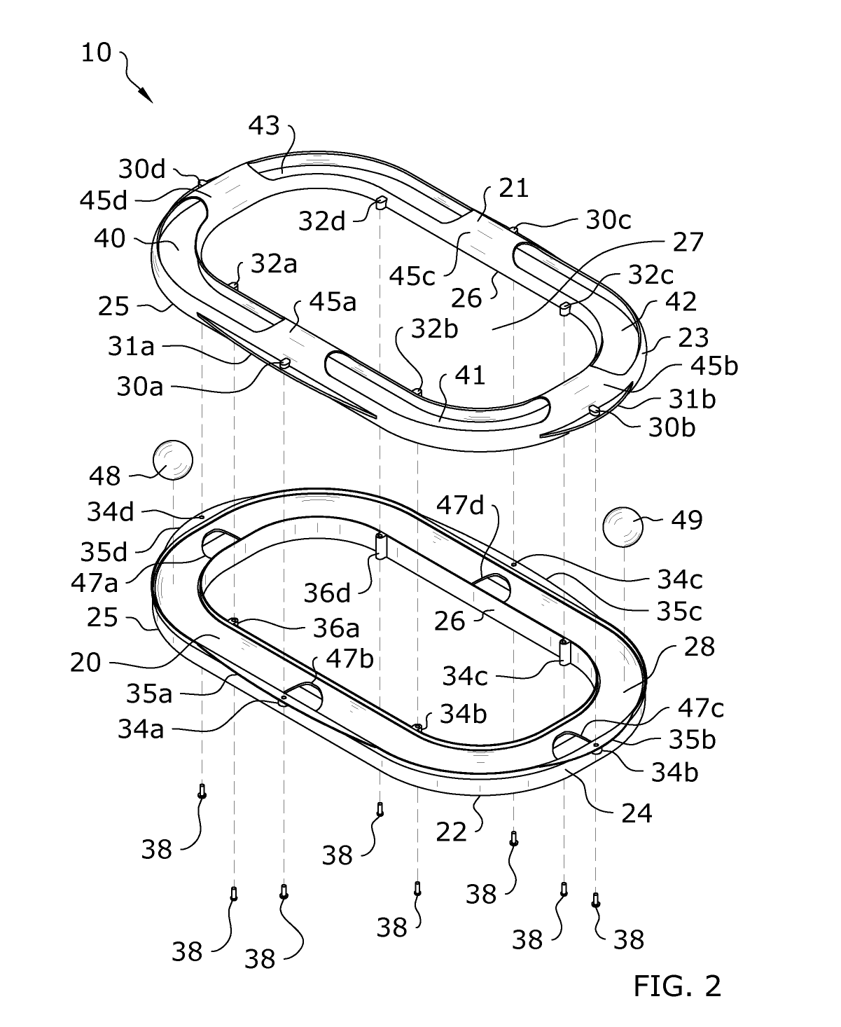

In embodiments in which the upper and lower portions 23, 24 of the track 20 are removably connected to each other, one or more connectors 30, 32, 34, 36 may be utilized. As best shown in FIG. 2, a preferred embodiment includes upper outer connectors 30 on the upper portion 23 which may be removably connected to lower outer connectors 34 on the lower portion 24. The upper outer connectors 30 are positioned on the outer edge 25 of the upper portion 23 of the track 20. The lower outer connectors 34 are positioned on the outer edge 25 of the lower portion 24 of the track 20 in positions such that the upper and lower outer connectors 30, 34 may be removably connected to each other, such as by fasteners 38 or the like.

The structure, number, and positioning of the upper and lower outer connectors 30, 34 may vary in different embodiments. In the figures, the upper outer connectors 30 comprise a first upper outer connector 30a, a second upper outer connector 30b, a third upper outer connector 30c, and a fourth upper outer connector 30d. Similarly, the lower outer connectors 34 comprise a first lower outer connector 34a, a second lower outer connector 34b, a third lower outer connector 34c, and a fourth lower outer connector 34d. Each of these upper and lower outer connectors 30, 34 are positioned at approximately ninety degree intervals in the figures, though other intervals may be utilized. Each of the upper and lower outer connectors 30, 34 generally comprises a structure with an opening extending therethrough for receiving a fastener 38. In a preferred embodiment as shown in the figures, each of the upper outer connectors 30 includes an upper outer flange 31 and each of the lower outer connectors 34 includes a lower outer flange 35. This configuration makes it simpler to align the upper outer connectors 30 with the lower outer connectors 34 to be removably connected to each other via fasteners 38.

Thus, as shown in the figures, the first upper outer connector 30a includes a first upper outer flange 31a, the second upper outer connector 30b includes a second upper outer flange 31b, the third upper outer connector 30c includes a third upper outer flange 31c, and the fourth upper outer connector 30d includes a fourth upper outer flange 31d. Similarly, the first lower outer connector 34a includes a first lower outer flange 35a, the second lower outer connector 34b includes a second lower outer flange 35b, the third lower outer connector 34c includes a third lower outer flange 35c, and the fourth lower outer connector 34d includes a third lower outer flange 35d. The upper and lower outer flanges 31, 35 are pressed against each other and secured together via the upper and lower outer connectors 30, 34 when the upper and lower portions 23, 24 of the track 20 are connected together.

As shown throughout the figures, the present invention may also include upper and lower inner connectors 32, 36 to more securely connect the upper and lower portions 23, 24 of the track 20 together. It should be appreciated that the present invention may include only outer connectors 30, 34, only inner connectors 32, 36, or a combination thereof. In embodiments utilizing both outer and inner connectors 30, 32, 34, 36, the outer connectors 30, 34 are positioned at different locations along the track 20 than the inner connectors 32, 36 such as shown in FIG. 2, which ensures that more secure connections are established along a greater length of the track 20.

Each of the upper and lower inner connectors 32, 36 generally comprises a structure with an opening for receiving a fastener 38. The structure, number, and positioning of the upper and lower inner connectors 32, 36 may vary in different embodiments. In the figures, the upper inner connectors 30 comprise a first upper inner connector 32a, a second upper inner connector 32b, a third upper inner connector 32c, and a fourth upper inner connector 32d. Similarly, the lower inner connectors 36 comprise a first lower inner connector 36a, a second lower inner connector 36b, a third lower inner connector 36c, and a fourth lower inner connector 36d. Each of these upper and lower inner connectors 32, 36 are positioned at approximately ninety degree intervals in the figures, though other intervals may be utilized.

### D. Openings

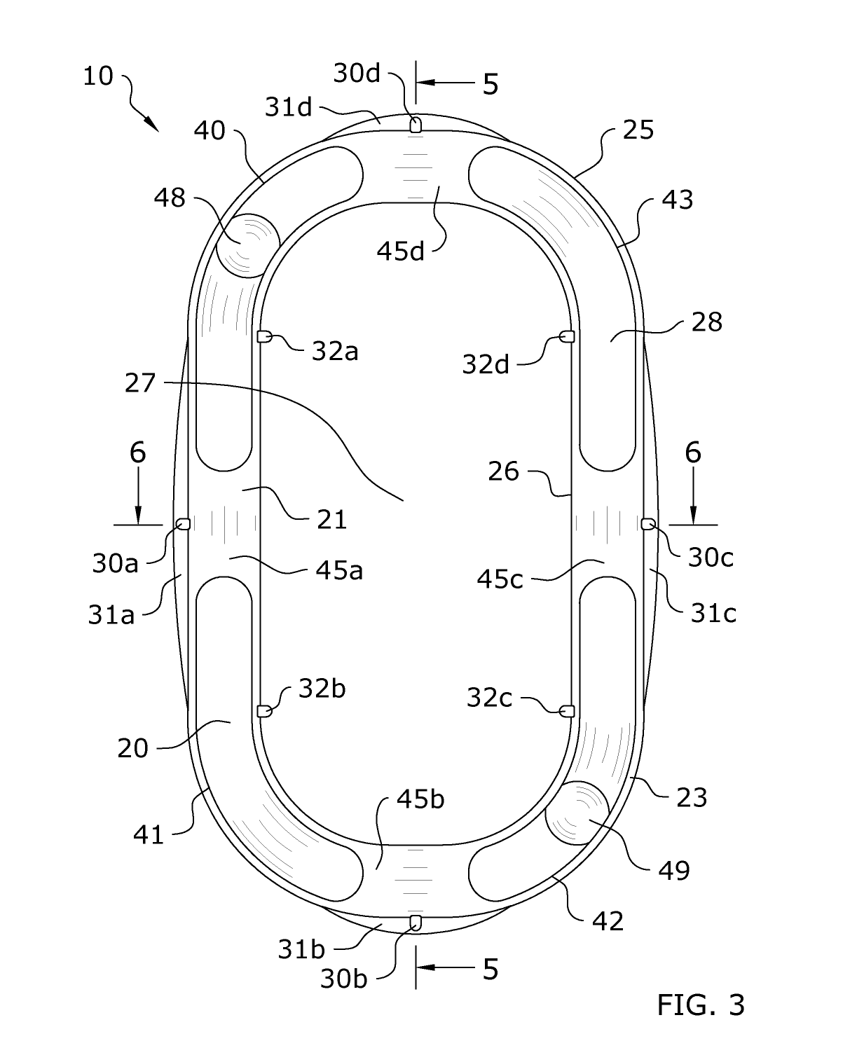

As best shown in FIG. 3, the upper end 21 of the track 20 may include one or more openings 40, 41, 42, 43 which provide access and a view to the underlying channel 28 of the track 20. Preferably, each of the openings 40, 41, 42, 43 will comprise an elongated opening formed in the upper end 21 of the track 20, such as on the upper portion 23 of the track 20. The configuration, shape, number, positioning, and length of the openings 40, 41, 42, 43 may vary in different embodiments of the present invention.

Preferably, the openings 40, 41, 42, 43 will be sized such that the balls 48, 49 may not be easily removed through any of the openings 40, 41, 42, 43 so that the balls 48, 49 remain within the channel 28 of the track 20 during use by an animal. Thus, the balls 48, 49 are each preferably slightly larger than the openings 40, 41, 42, 43. Each of the balls 48, 49 requires applied force to snap into the track 20 through any of the openings 40, 41, 42, 43 wherein the balls 48, 49 engage the opposing edges of the openings 40, 41, 42, 43 as the balls 48, 49 are forced through the openings 40, 41, 42, 43 by the user. The balls 48, 49 may be removed through the openings 40, 41, 42, 43 by the user pulling the balls 48, 49 through the openings where the balls 48, 49 also engage the edges of the openings 40, 41, 42, 43 when pulled out by the user for replacement or repair.

In a preferred embodiment, the track 20 includes openings 40, 41, 42, 43 which are elongated but extend for discrete intervals. In the embodiment shown in the figures, the upper portion 23 of the track 20 includes a first opening 40, a second opening 41, a third opening 42, and a fourth opening 43. The first opening 40 extends over a first corner of the track 20, the second opening 41 extends over a second corner of the track 20, the third opening 42 extends over a third corner of the track 20, and the fourth opening 43 extends over a fourth corner of the track 20.

It should be appreciated that any type of ball 48, 49 may be utilized, such as the exemplary balls as shown in the figures or any other ball capable of being pushed around the track 20. While the openings 40, 41, 42, 43 allow the animal to view the balls 48, 49 as they traverse the track 20, one or more enclosed portions 45 may also be included to conceal the balls 48, 49 from view as they traverse certain portions of the track. This will increase the amusement of the animal, as the balls 48, 49 will periodically disappear from view. Each of the enclosed portions 45 either fully or partially cover the openings 40, 41, 42, 43 at certain portions along the length of the track 20. For example, the enclosed portions 45 may extend fully between the outer and inner edges 25, 26 of the track 20 or may extend only partially between the outer and inner edges 25, 26 thereof. The enclosed portions 45 will generally comprise a material which at least partially obscures the view of the underlying balls 48, 49 from above. Thus, the enclosed portions 45 may be opaque, semi-translucent, or non-translucent. The positioning, shape, size, and configuration of the enclosed portions 45 may vary. In the embodiment best shown in FIG. 3, a first enclosed portion 45a is positioned between the first and second openings 40, 41, a second enclosed portion 45b is positioned between the second and third openings 41, 42, a third enclosed portion 45c is positioned between the third and fourth openings 42, 43, and a fourth enclosed portion 45d is positioned between the first and fourth openings 40, 43.

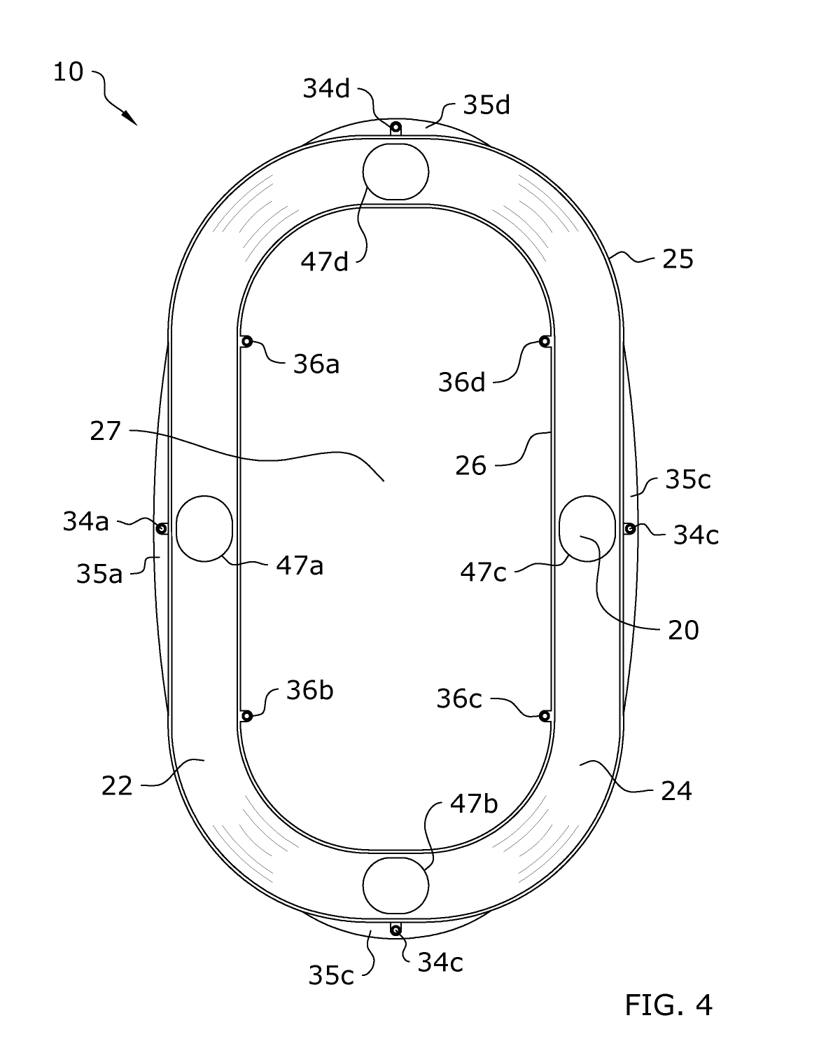

As best shown in FIG. 4, the lower portion 24 of the track 20 may include one or more ball stops 47 adapted to slow down or impede motion of the balls 48, 49 through the channel 28 of the track 20. The shape, size, number, positioning, and configuration of ball stops 47 may vary in different embodiments of the present invention. In a preferred embodiment as shown in FIG. 2, the ball stops 47 are each positioned underneath a corresponding enclosed portion 45 of the upper portion 23 of the track 20.

Thus, in a preferred embodiment as shown in FIG. 2, a first ball stop 47a is positioned underneath the first enclosed portion 45a, a second ball stop 47b is positioned underneath the second enclosed portion 45b, a third ball stop 47c is positioned underneath the third enclosed portion 45c, and a fourth ball stop 47d is positioned underneath the fourth enclosed portion 45d. Such a configuration causes the balls 48, 49 to slow or stop underneath the enclosed portions 45 to the amusement of the animal using the present invention.

The ball stops 47 may comprise different types of structures. In some embodiments such as shown in the figures, the ball stops 47 comprise openings in the lower portion 23 of the track 20. In other embodiments, the ball stops 47 could comprise bumps, textured surfaces, or other similar structures which would act to impede or stop movement of the balls 48, 49 as they pass thereover.

### E. Base

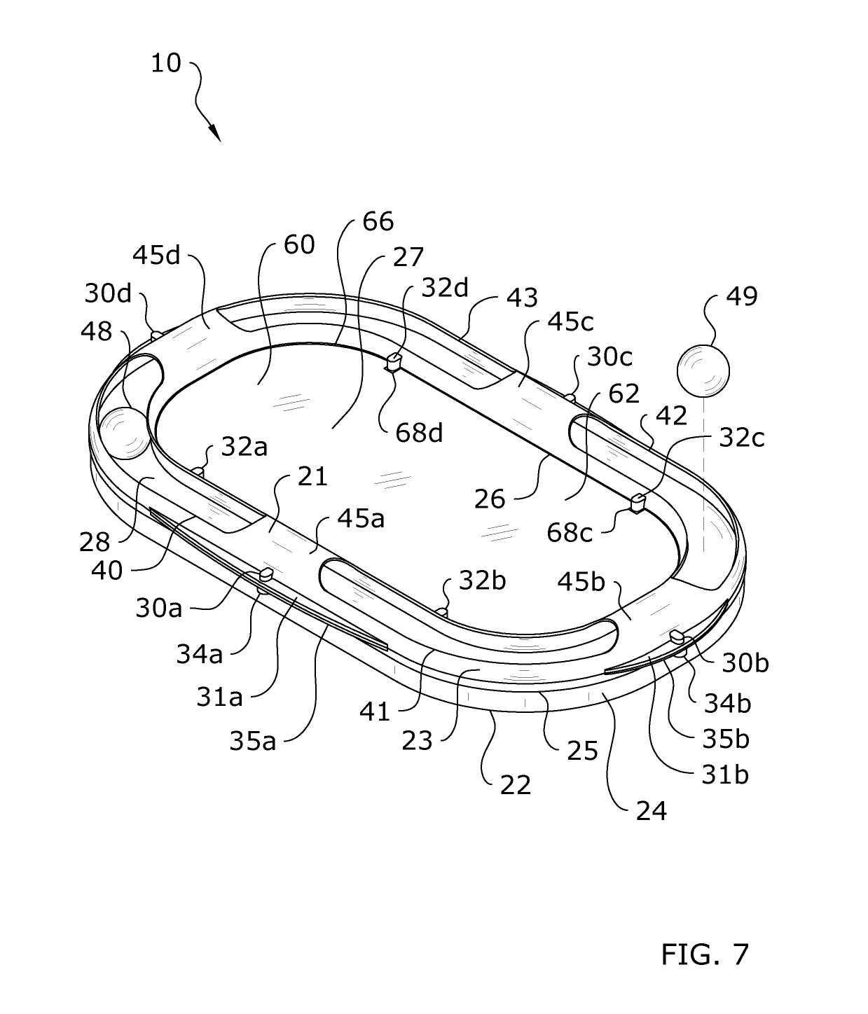

An alternate embodiment of the present invention including a base 50 is shown in FIGS. 7-15. In such an embodiment, a base 50 fills the central opening 27 of the track 20. The base 50 covers the central opening 27 so that the animal may stand or rest on the base 50 rather than the underlying ground.

As shown in the figures, the base 50 includes an upper end 52 and a lower end 54. The animal will stand or lay upon the upper end 52 of the base 50 when the present invention is in use. The lower end 54 of the base 50 rests against the ground, floor, or other underlying surface of the track 20.

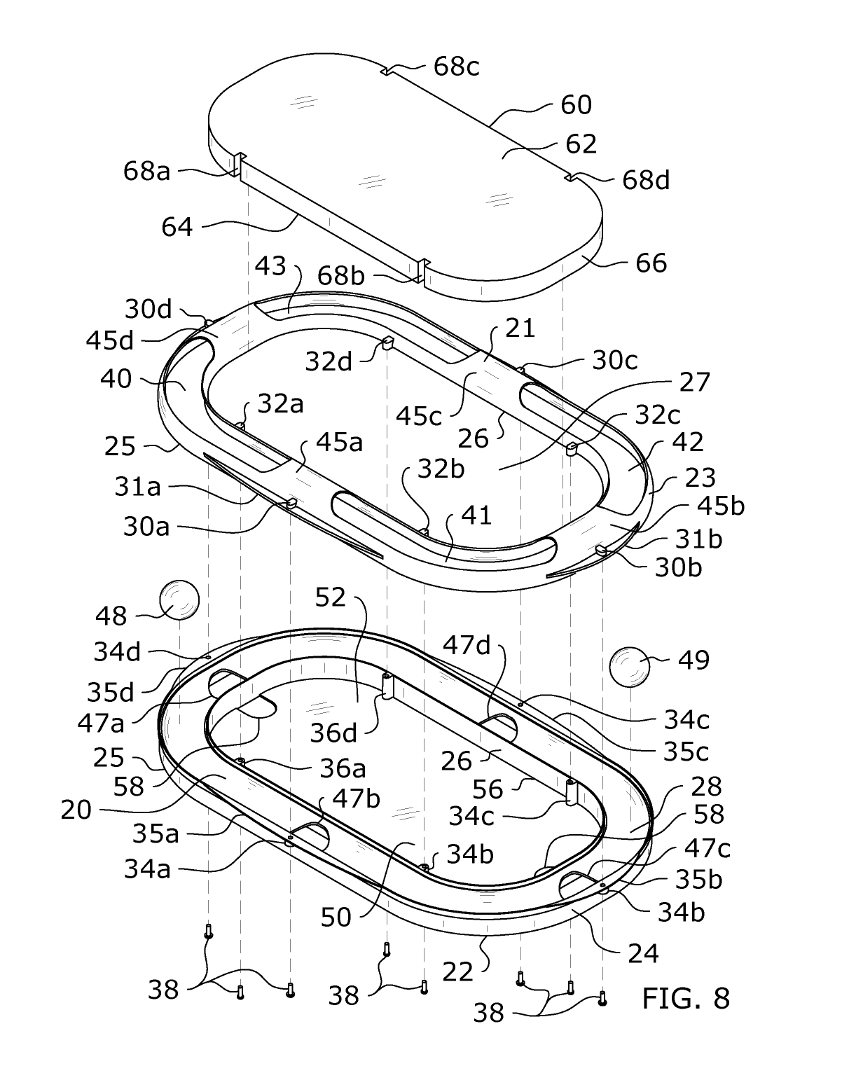

The base 50 may include a retrieval cutout 58 as shown in FIG. 8. The retrieval cutout 58 comprises an opening within the body of the base 50. In the figures, the retrieval cutout 58 is illustrated as being positioned adjacent the inner edge 26 of the track 20. It should be appreciated that alternate positioning may be utilized. The retrieval cutout 58 eases removal of the insert 60 when needed as discussed herein.

### F. Insert

As shown in FIG. 8, the present invention includes an optional insert 60 which may be placed removably within the central opening 27 of the track 20. The insert 60 may comprise cardboard, carpeting, scratch pad, or the like. The insert 60 is utilized to provide a structure on which the animal may rest, scratch, lounge, sit, stand, or the like.

The insert 60 will generally have the same shape as the central opening 27 of the track 20. The insert 60 includes an upper end 62 on which the animal will stand and a lower end 64 which will contact either the floor or the base 50 of the track 20, if an embodiment with a base 50 is being utilized.

The outer edge 66 of the insert 60 may include a plurality of connector cutouts 68 so that the insert 60 may be fully inserted into the central opening 27 of the track 20. Preferably, the upper end 62 of the insert 60 should be approximately flush with the upper end 21 of the track 20.

In a preferred embodiment as shown in the figures, the insert 60 includes a first connector cutout 68a for receiving the first inner connectors 32a, 36a, a second connector cutout 68b for receiving the second inner connectors 32b, 36b, a third connector cutout 68c for receiving the third inner connectors 32c, 36c, and a fourth connector cutout 68d for receiving the fourth inner connectors 32d, 36d.

### E. Operation of Preferred Embodiment

In use, the track 20 is first assembled if not already. The upper portion 23 of the track 20 is aligned and lowered onto the lower portion 24 of the track 20. The balls 48, 49 should be placed in the lower portion 24 of the track 20 prior to lowering the upper portion 23 down thereonto.

The upper outer connectors 30 of the upper portion 23 will contact the lower outer connectors 34 of the lower portion 24. The upper inner connectors 32 of the upper portion 24 will similarly contact the lower inner connectors 36 of the lower portion 24. With all connectors 30, 32, 34, 36 in position, fasteners 38 may be utilized to secure the outer connectors 30, 34 to each other and to secure the inner connectors 32, 36 to each other. With the upper and lower portions 23, 24 of the track 20 so interconnected, the channel 28 will be defined therebetween through which the balls 48, 49 may be forced by an animal.

In embodiments which include an insert 60, the insert 60 is lowered into the central opening 27 of the track 20 to rest therein. If the track 20 includes a base 50, the insert 60 will rest on the base 50. If the track 20 does not include a base 50, the insert 60 will simply be retained within the central opening 27 of the track 20 and contact the underlying ground. In either case, the connector cutouts 68 will allow the insert 60 to be flush with the upper portion 23 of the track 20.

With the present invention fully assembled, the track 20 may be put into a location ideal for the animal to find and play with it. An animal will see the balls 48, 49 within the track 20 and swat at them. The balls 48, 49 will traverse the track 20 and give the illusion of disappearing as they pass under the enclosed portions 45 of the upper portion 23 of the track 20. Additionally, the ball stops 47 will cause the balls 48, 49 to slow down and stop at different places to the additional amusement of the animal using the present invention. When desired, the animal may rest in the central opening 27, such as on the insert 60 if one is present.

When needed, the upper and lower portions 23, 24 of the track 20 may be disconnected to clean the channel 28 of fur and the like. Similarly, the balls 48, 49 may be cleaned or replaced while the upper and lower portions 23, 24 are disconnected. The insert 60 may freely be exchanged, such as when a scratch pad has been worn from repeated use by an animal.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

The invention claimed is:

1. An animal amusement system, comprising:
a track comprising an upper portion and a lower portion, wherein said upper portion includes at least one enclosed portion;
a channel in said lower portion of said track;
a first opening formed within said upper portion of said track, wherein said first opening provides a view of said channel; and
a ball stop in said lower portion of said track.

2. The animal amusement system of claim 1, wherein said track includes an outer edge and an inner edge, wherein said track includes a central opening defined by said inner edge.

3. The animal amusement system of claim 2, further comprising a base within said central opening.

4. The animal amusement system of claim 2, further comprising an insert for removably positioning within said central opening.

5. The animal amusement system of claim 4, wherein said insert comprises a scratch pad.

6. The animal amusement system of claim 1, wherein said first opening is comprised of an elongated opening.

7. The animal amusement system of claim 1, wherein said ball stop comprises a depression in said lower portion of said track.

8. The animal amusement system of claim 1, further comprising a second opening formed within said upper portion of said track, wherein said first opening and said second opening are separated by an enclosed portion.

9. The animal amusement system of claim 8, wherein said ball stop is positioned underneath said enclosed portion.

10. The animal amusement system of claim 1, further comprising a ball movably positioned within said channel of said track, wherein said ball is larger than said first opening.

11. An animal amusement system, comprising:
a track comprising an upper portion and a lower portion, wherein said upper portion includes at least one enclosed portion;
a channel in said lower portion of said track;
a first opening formed within said upper portion of said track, wherein said first opening provides a view of said channel;
a second opening formed within said upper portion of said track;
an enclosed portion separating said first opening from said second opening; and
a ball stop in said lower portion of said track, wherein said ball stop is positioned underneath said enclosed portion.

12. The animal amusement system of claim 11, further comprising a ball movably positioned within said channel of said track, wherein said ball is larger than said first opening.

13. The animal amusement system of claim 11, wherein said upper portion is removably connected to said lower portion by one or more connectors.

14. The animal amusement system of claim 13, wherein said one or more connectors comprise a plurality of upper outer connectors on said outer edge of said upper portion of said track and a plurality of lower outer connectors on said outer edge of said lower portion of said track.

15. The animal amusement system of claim 14, wherein said one or more connectors further comprise a plurality of upper inner connectors on said inner edge of said upper portion of said track and a plurality of lower inner connectors on said inner edge of said lower portion of said track.

16. The animal amusement system of claim 11, further comprising a base secured within said central opening.

17. The animal amusement system of claim 11, further comprising an insert for removably positioning on said base.

18. The animal amusement system of claim 17, wherein said base includes a retrieval cutout for removing said insert from said base.

19. The animal amusement system of claim 18, wherein said insert comprises a scratch pad.

20. The animal amusement system of claim 11, wherein said ball stop comprises an opening formed in said lower portion of said track.
